(19) United States
(12) Patent Application Publication
(10) Pub. No.: US 2013/0054195 A1
(43) Pub. Date: Feb. 28, 2013

(54) Low Power, Multi-Channel Pulse Data Collection System and Apparatus

(71) Applicants: Hollis H. Jones, Gassville, AR (US); Federico A. Herrero, Glenn Dale, MD (US); Duncan M. Kahle, Washington, DC (US)

(72) Inventors: Hollis H. Jones, Gassville, AR (US); Federico A. Herrero, Glenn Dale, MD (US); Duncan M. Kahle, Washington, DC (US)

(73) Assignees: National Aeronautios and Space Administration, Washington, DC (US); United States of America as represented by the Administrator of the

(21) Appl. No.: 13/216,479

(22) Filed: Aug. 24, 2011

(51) Int. Cl. G06F 17/40; G06M 3/00

(52) U.S. Cl. 702/187; 377/26

(57) ABSTRACT

The present invention is directed to a system and apparatus employing an ultralow power, pulsed data collection apparatus having multiple detector channels, such as 64 channels. The system and apparatus has a small volume and power requirements, enabling launch and deployment from commercial spacecraft, such as pursuit to the CubeSat and other nanosatellite protocols.

### ORIGIN OF THE INVENTION

The invention described herein was made by an employee of the United States Government, and may be manufactured and used by or for the Government for governmental purposes without the payment of any royalties thereon or therefor.

### BACKGROUND OF THE INVENTION

1. Field of the Invention

The present invention is in the technical field of data collection, such as in miniature satellite systems.

2. Description of Related Art

The exploration of space is an ongoing adventure. Technological advancements open new avenues of exploration. One such application is the collection of particles in the upper atmosphere, such as the ionosphere.

Conventional instrumentation for the collection of such particles and data consumes large amounts of power and are bulky, serious constraints in space exploration. Such instruments include expensive time-of-flight circuitry, charge sensitive amplifiers, and other such problematic devices. These problems include slow capture rates, such as with the charge sensitive amplifiers, and the requisite larger volumes needed to contain the bulky prior art electronics.

These problems are magnified by budget shortfalls, making solutions to the power, volume and weight factors a priority. For example, the National Science Foundation (NSF) has launched a program to encourage the development of CubeSat technologies and applications, directed to provide practical, reliable, and cost-effective launch opportunities for small satellites and their payloads. CubeSat offers satellites with volumes in multiples of 4×4×4 inches. Regarding power, these proposed satellites have an electric bus with a total power of less than about 4 watts. Thus, instrumentation launched for his program must have less power requirements lest the batteries be drained.

There is, therefore, a need to provide miniaturized instrumentation that consumes less power, has less weight and takes up less volume, enabling the launch of such instrumentation in commercial spacecraft. Indeed the mantra of faster, better and cheaper applies.

There is also a need for an improved mass spectrometer that has enhanced capabilities and meets the requirements for such miniaturized instrumentation and commercial launches.

There is a further need for a mass spectrometer having more detectors and detection capabilities to better count pulse hits from particles, i.e., ions or neutrals, in the upper atmosphere.

### SUMMARY OF THE INVENTION

The present invention is directed to a system and apparatus employing an ultralow power, pulsed data collection apparatus having multiple detector channels, such as 64 channels. The system and apparatus has a small volume and power requirements, enabling launch and deployment from commercial spacecraft, such as pursuit to the CubeSat and other nanosatellite protocols.

### BRIEF DESCRIPTION OF THE DRAWINGS

While the specification concludes with claims particularly pointing out and distinctly claiming the subject matter that is regarded as forming the present invention, it is believed that the invention will be better understood from the following Detailed Description, taken in conjunction with the accompanying Drawings, where like reference numerals designate like structural and other elements, in which:

FIG. 1 illustrates a block diagram description of a conventional electron packet encounter;

FIG. 2 illustrates a functional block diagram of a dual binary counter chip; and

FIG. 3 illustrates a functional block diagram of a multi-channel, pulse data collection system board pursuit of the teachings of the present invention.

### DETAILED DESCRIPTION OF THE INVENTION

The present invention will now be described more fully hereinafter with reference to the accompanying Drawings, in which preferred embodiments of the invention are shown. It is, of course, understood that this invention may, however, be embodied in many different forms and should not be construed as limited to the embodiments set forth herein; rather, these embodiments are provided so that the disclosure will be thorough and complete, and will fully convey the scope of the invention to those skilled in the art. It is, therefore, to be understood that other embodiments can be utilized and structural changes can be made without departing from the scope of the present invention.

As discussed the current deployment of satellites and other high altitude instrumentation, partly with the end of the United States' Shuttle program, relies increasingly on commercial spacecraft. Instrumentation must be smaller to fit into these miniaturized payloads, have lower power consumption to be able to operate, and be ever more sophisticated.

The present invention addresses one such application and a proposed solution to the aforementioned deployment problems affecting all prior art instrumentation, such as mass spectrometers and other pulse counting-type detectors for space exploration and discovery. Particularly the present invention is directed to an innovative system, apparatus and methodology, using mass spectrometer technologies developed at NASA's Goddard Space Flight Center. The proposed system and apparatus will enable a suite of instruments for Ionosphere-Thermosphere investigations in a smaller satellite, e.g., pursuit to CubeSat or other nano-satellite protocols, and consume less than 1.5 W total power, thereby well under the low energy threshold of such commercial or other satellites, and not draining the batteries thereof.

It should, of course be understood that the present invention may also be adapted for use in other types of spectrometers compatible with the CubeSat dimensions, and to many other applications with high speed pulse signals coming from particles or photons.

Indeed, the system and apparatus of the present invention as explained in the instrumentation described hereinbelow, offer an enhanced ability to seamlessly collect multichannel data, i.e., across 16, 32, 64, 128, 256, 512 or 1,024 channels, with improvement on the detection capability of prior such devices. For example, using a presently-preferred 64 channel detector, the satellite greatly improves detection on the angle of entrance while flying through the ionosphere. With the other instrumentation enhancements set forth herein, such detectors are better able to accurately detect, measure, or count particles or photons during operation even in heavy count conditions, providing more accurate data collection.

As also discussed, the above improvements in detection and data collection are accomplished with unprecedented low power, e.g., about <500 mW, <250 mW, <200 mW, <100 mW, <50 mW or <25 mW, as is understood in the art. The presently-preferred embodiment, employing 64 channels, as configured, uses less than 100 mW, as set forth hereinbelow. With miniaturization, this instrumentation can easily fit into the smaller payloads of commercial launch vehicles, and single or multiple suites may be so deployed. In addition, the system and apparatus of the present invention are preferably easily adapted to command and data handling hardware, e.g., microcontrollers, field programmable gate arrays (FPGAs) or other such integrated circuitry, National Instruments (NI) cards, and other hardware.

It should also be understood than the system and apparatus of the present invention is transportable to an Application Specific Integrated Circuit (ASIC) design, thereby better ensuring a place in nano-sat technology. It should, therefore, be understood that the description herein for apparatus encompasses ASIC instrumentation for same.

Furthermore, the principles of the present invention have commercial applications, especially in ASIC form, for a variety of industries, particularly space weather and GPS support in ionosphere-thermosphere applications. The present invention may also be employed in aiding the determination of drag coefficients and support for orbit lifetime analysis. Other commercial applications include optical pulse spectrometers for industrial monitoring and for homeland security.

The present description is directed to a presently-preferred 64-channel, pulse data collection system (64-PDCS). It should, of course, be understood that the principles of the present invention may also be applicable to other channel sizes, preferably a power of two to avoid waste, e.g., 16, 32, 128 and 256. It should be understood that although fewer than the maximum channels may be employed, leaving one or more channels unused. As is understood in the art, these devices can have many roles in science measurements. In the context of the instant invention, a preferred embodiment is directed to novel mass spectrometry techniques. In general an array or an arrangement of up to 64 anodes in this embodiment placed under a micro channel plate (MCP) receives packets of electrons in response to negative or positive charged particles, such as electrons and ions, or photons. The packets form small negative voltages across termination resistors that are counted to reflect the density of the neutrals and ions. A purpose of the 64-PDCS is to collect, store and transmit the number of pulses received within a given time frame to a command and data handling (C&DH) system with minimum hardware interconnection as well as minimum power dissipation (<100 mW). The rate of collection is preferably approximately 10⁶ pulses per second per channel with a count ceiling of 65536 pulses—a maximum frame or window of ˜65.5 ms.

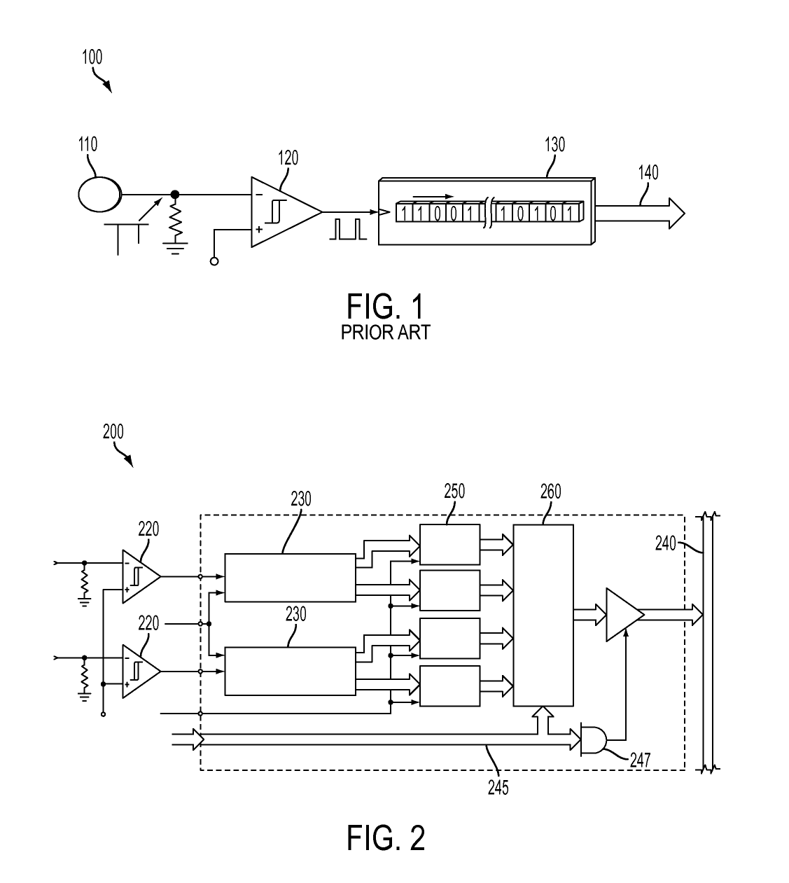

With reference now to FIG. 1 there is illustrated therein the basics of the aforementioned pulse-counting concept, generally designated by the reference numeral 100, which includes an anode 110, a comparator 120 and a counter 130, such as a 16-bit counter. Functionally, when an electron packet strikes the anode 110, if the negative-going voltage crosses the negative threshold voltage V_{ref}, the output of the comparator 120 responds with a positive pulse. The pulse causes the counter 130 to advance its count by one. Another packet advances the counter 130 once more and so on. The resulting count (from 0 to 65535—or hex FFFF) is placed on a 16-bit data bus 140 for routing to storage. Not shown, but understood in the art, are inputs that clear (reset) the counter to zero or latch the current count in order to continue counting, such as may be controlled by a microcontroller or FPGA. It should be understood that the number of counts in a spectrometry operation reflects the particle density.

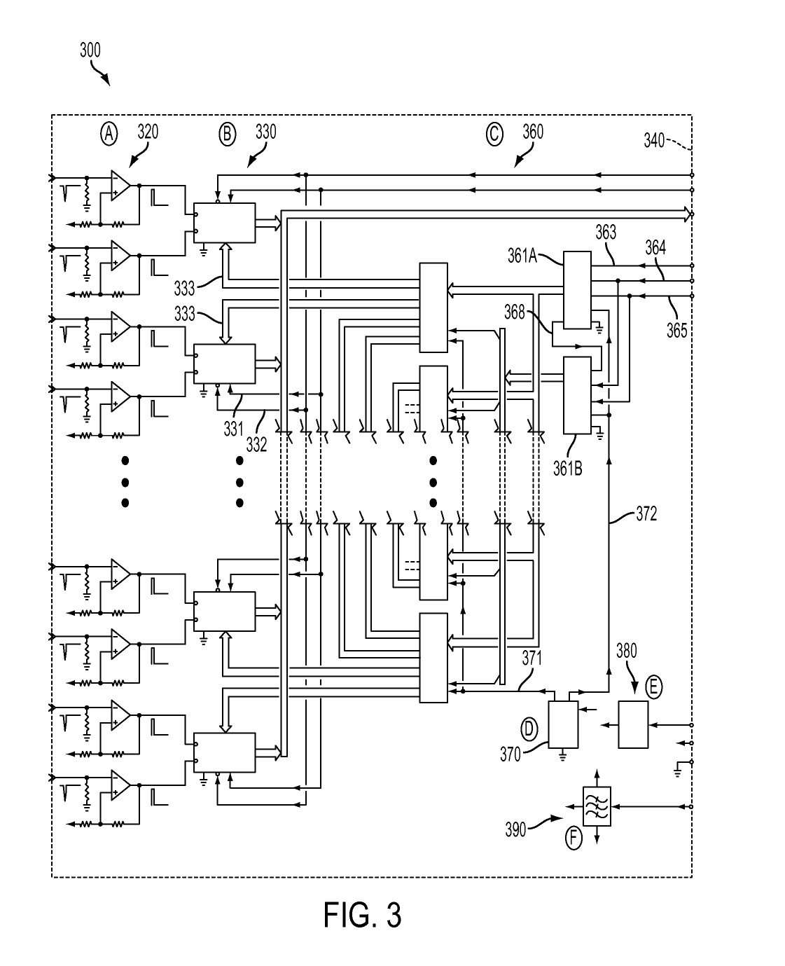

In order to better understand the principles of the present invention (and the economy of the design), the internal functions of a more advanced counter, such as Texas Instrument's 74LV8154, a dual-binary counter IC, is depicted in FIG. 2, and generally designated by the reference numeral 200. Further details of the IC 200 will be discussed hereinbelow, but only those functions implemented in the IC chip for the 64-PDCS are displayed in order to understand the present invention better.

Although anodes 110 are not shown in FIG. 2, the same functionality applies as in FIG. 1, i.e., positive pulses from two independent comparators 220 are routed into clock inputs of a dual counter 230 in response to negative voltages at the inverting inputs that cross the common V_{ref} at the non-inverting inputs. There are two independent counters 230 in the same IC 200 advancing their count in response to clock inputs (CCKA and CCKB). Each counter 230, however, splits the resulting count into upper and lower bytes, as shown in FIG. 2. The counts are continually sent into four separate registers 250 (two registers for each counter per upper and lower bytes) but do not proceed onto the next block (decoder 260) until RCLK is pulsed by the “Latch” input (active high). When RCLK is quiet, the last count in each register 250 is held for processing. After the latching event, “Clear” is issued (pulsed low), resetting both counters 230 to zero in order to resume the counting process while the previous latched binary counts are multiplexed onto the data bus 240.

As shown in FIG. 2, the multiplexing operation of the IC chip 200 is accomplished by four lines in the “Gxx” bus, generally designated by the reference numeral 245. These active low lines, labeled GAL, GAU, GBL, and GBU, as set forth in the figure, control the 4-to-1 decoder according to the values set forth in Table 1 hereinbelow. As shown, there are only five valid states, of which in four states, a logic low is “bubbled” through the logic high Gxx lines 245 in order to multiplex each counter's half-byte value. As shown by the AND logic gate 247 in FIG. 2, when the Gxx lines 245 are all logic high, the output goes into a high impedance state, removing it from the data bus 240, allowing other IC 200 devices, such as 74LV8154 counter chips to share the same bus.

TABLE 1

| GAL | GAU | GBL | GBU | Output |
|---|---|---|---|---|
| L | H | H | H | Lower byte of counter A |
| H | L | H | H | Upper byte of counter A |
| H | H | L | H | Lower byte of counter B |
| H | H | H | L | Upper byte of counter B |
| H | H | H | H | Hi-Z state |

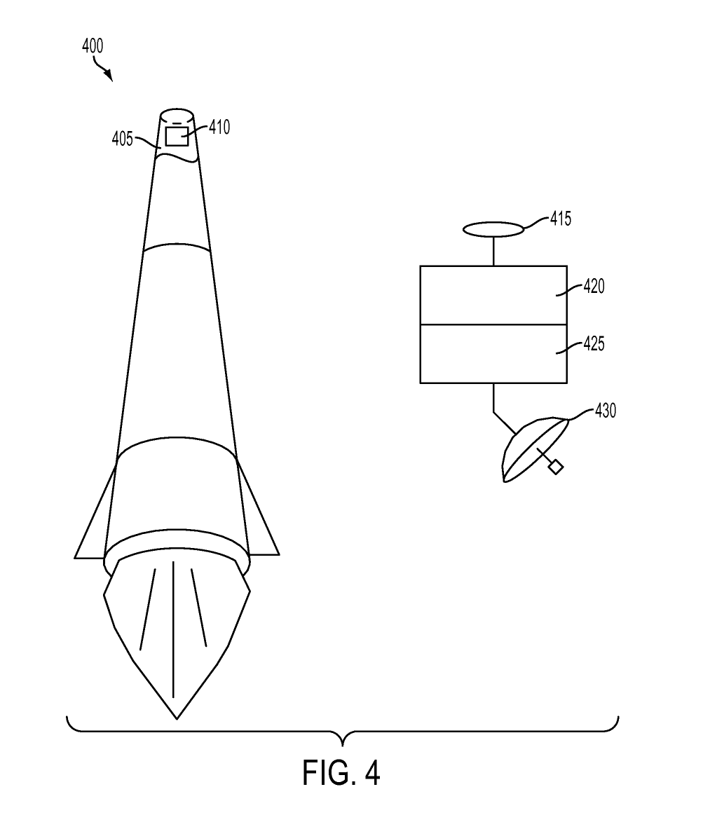

With the single-channel basics and other aspects of the design expressed, the example of a 64-channel version will now be discussed. FIG. 3 of the drawings illustrates a functional block diagram of an ultra-low power design of a 3.8″ diameter board that counts, temporarily stores, and transmits 64 count values on request to any command and data handling system, generally designed by the reference numeral 300. The sections in FIG. 3 labeled ‘A’ through ‘F’ are broken up into separate descriptions hereinbelow.

### Comparators

With reference now to section A in FIG. 3, there are illustrated comparators, generally designated by the reference numeral 320. To detect high speed pulses (˜4 ns), the present invention preferably employs at least one comparator, such as Maxim's MAX9144IC, a quad, low power, high speed, near rail-to-rail output comparator 320. With a supply voltage range of 3.3V and ground, the comparator 320 inputs can go down to ˜300 mV with a 40 ns propagation delay time (at 10 mV overdrive) while consuming only ˜150 μA per comparator (at +25° C.). It should be understood that a comparator, such as the MAX9144 IC, is preferred because it can go below its voltage rail. The power dissipation per comparator 320 then is 49 μW (˜0.5 mW), or per quad comparator chip, 1.98 mW (˜2 mW/chip). Per chip, this comes out to be 1.98 mW or roughly 2 mW/chip. If the entire 64-channel configuration is used, the total watts due to the 64 comparators is 31.7 mW, or approximately 32 mW.

Each input is connected to the comparator's 320 inverting input, referenced to ground via a 50Ω termination resistor, the value of which is chosen to reduce ringing, as is shown in FIG. 3 and as understood in the art. With further reference to FIG. 3, connection to the inverting pin causes the output to give a positive response for a negative pulse. The non-inverting input is connected to a common negative reference through a resistor<1 kΩ. The reference is programmable by the user, but nominally, for a negative pulse, such as in this application on the order of −50 mV. As further shown in FIG. 3, a larger resistance (˜270 kΩ) connects the output to the non-inverting input to provide additional noise margin (˜10 mV) on top of the built-in 1.5 mV hysteresis of the IC. This feedback resistor with the stray capacitance (<1 to 2 pF) consumes additional (transient) current adding only slightly to the power dissipation.

Other features of comparator 320 include: 1) built-in input protection diodes, 2) input offset voltage of 0.5 mV, 3) input bias current of 90 nA, 4) small input offset current of 8 nA, 5) 80 μV/V common mode and power supply rejection ratio, and finally, 6) a 14-pin TSSOP footprint package with 0.65 mm (0.026″) pitch.

The output of the comparators 320 drive the clock inputs of the 74LV8154 dual binary counters 330, as described hereinbelow.

### Binary Counters

With reference now to section B in FIG. 3, there are illustrated counters, generally designated by the numeral 330. A preferred counter 330, such as SN74LV8154, an LVTTL family chip by Texas Instruments, is used to keep track of the number of hits within a time interval by storing the count internally. This chip is a dual 16-bit binary counter with 3-state output registers, thus allowing the system to seamlessly count and report the previous count at the same time (dead time<50 ns), as well as having many chips (up to 32) share the same 8-bit data bus.

It should be understood that although most of the internal functions were set forth in FIG. 2, they are reiterated here. As shown in FIG. 3, the IC 300 includes two separate 16-bit counters 330 (A and B), with 32 latches—one for every counter's output, and user-accessible 4-to-1 decoders 360 with tri-state buffers to allow individual reporting of the counters—8 bits at a time. Thus in four cycles, the upper and lower words of the two counters 330 can be retrieved on the data bus 340.

The counters 330 are randomly clocked by the aforementioned two front-end comparators 320 at the pins CCKA (counter A clock) and CCKB (counter B clock). It should be understood that the counters 330 in the present example employ random clocking for mass spectrometry, other clocking is possible for other applications, i.e., periodic or aperiodic. The operation to retrieve the count values from the aforementioned counter 74LV8154 was described above. To extract the counts, the following sequence is used: 1) A pulse counter latch 331 pulses all 74LV8154 RCLKs high in order to latch all counts. 2) A pulse counter clear 332 then pulses all 74LV8154s logic low in order to reset the binary counters. After these global events, the counters 330 resume counting. 3) A logic low is then bubbled through Gxx lines, generally designated by the reference numeral 333, on each individual chip. The Gxx lines 333 on the other 31 dual-binary chips are held logic high to maintain high impedance states—this separation is achieved by decoders 360 described below. Only one low is allowed on the Gxx lines 333; otherwise, the output may be invalid. TABLE 1 above gives the logic steps necessary for each chip and are repeated chip-to-chip 32 times, as is understood in the art.

The temperature range for the counters 330 is −40° C. to 85° C. and has a 20-pin TSSOP footprint with 0.65 mm (0.026″) pitch. The quiescent supply current is I_{cc}=20 μA and the input leakage currents are Iᵢ=1 μA. The power supply dissipation per chip is Pₛ=66 μW/chip. The input capacitance is 3 pF and the power dissipation capacitance is C_{PD}=56 pF.

### Decoders

With reference now to section C in FIG. 3, there are illustrated decoders, generally designated by the numeral 360. A purpose of the decoders 360 in the present invention is to select which counter 330, such as the aforementioned 74LV8154 chip, is accessed, which counter (A or B) is accessed, and which byte (upper or lower) is put on the data bus 340. The decoding is preferably achieved with registers 361, preferably two of NPX's (Philip's) HC family logic chips, the 74HC595—an 8-bit shift register, and a decoder 362, preferably the 74HC154-4-to-16 Decoder/Demultiplexer. As shown in FIG. 3, there are two 8-bit shift registers 361A and 361B (top and bottom) and eight 4-to-16 decoders 362 on the board collectively referred to herein as “decoders.” All are preferably rated at −40° C. to 85° C. and have TSSOP footprints. The 74HC154 decoded is a 24 lead and the resister 74HC595 is a 16 lead—both have a 0.65 mm (0.026″) pitch.

The decoders 360 are preferably serially controlled by a command and data handling system (SPI data/clock and one control line) using three lines in which to issue bit patterns: a data line 363 (ser-decode data), a global clock 364 (ser-decode clk), and a global latch 365 (ser-decode latch). As shown in FIG. 3, 16-bit patterns are clocked into and through the top shift register 361A to the bottom shift register 361B internally—that is, the data is not transparent on outputs Q0-Q8, until ser-decode latch 365 places the pattern onto the 4-bit decoder bus 366 and the 8-bit decoder-enable bus 367. Only the four top bits of the first serial register are used—these control the Gxx lines 333 of the 74HV8154 counters 330 via the 4-to-16 decoders 360. Shown in FIG. 3, the Q7′ bit of the top shift register 361A is the data line 368 to the bottom serial register 361B, which uses all 8-bits to separately enable the eight 4-to-16 decoders 360 individually. In other words, a low is bubbled through the normally logic high lines. Every 4-to-16 decoder chip controls four 74LV8154 chips; only one 4-to-16 decoder chip is allowed to be “on” at the same time.

The bit patterns to retrieve the binary counts are set forth by example in TABLE 2 hereinbelow.

TABLE 2

| Bit Pattern | Result |
|---|---|
| 11111110xxxx0000 | Binary counter chip #1, lower byte of counter A |
| 11111110xxxx0001 | Binary counter chip #1, upper byte of counter A |
| 11111110xxxx0010 | Binary counter chip #1, lower byte of counter B |
| 11111110xxxx0011 | Binary counter chip #1, upper byte of counter B |
| 11111110xxxx0100 | Binary counter chip #2, lower byte of counter A |
| etc. until 16^{th} pattern | Then, bubble over ‘0’ in bit pattern . . . |
| 11111101xxxx0000 | Binary counter chip #5, lower byte of counter A |
| 11111101xxxx0001 | Binary counter chip #5, upper byte of counter A |
| 11111101xxxx0010 | Binary counter chip #5, lower byte of counter B |
| 11111101xxxx0011 | Binary counter chip #5, upper byte of counter B |
| etc. until N^{th} chip | Then, . . . assuming N = 32, bubble ‘0’ to end . . . |
| is reached . . . | |
| 01111111xxxx1100 | Binary counter chip #32, lower byte of counter A |
| 01111111xxxx1101 | Binary counter chip #32, upper byte of counter A |
| 01111111xxxx1110 | Binary counter chip #32, lower byte of counter B |
| 01111111xxxx1111 | Binary counter chip #32, upper byte of counter B |
| Repeat . . . | . . . |

The quiescent current for the 74HC595 decoder 360 is 8 μA or 160 μA for both chips giving a total of P_{d}=528 μW. The input capacitance on all inputs are 3.5 pF and the power dissipation capacitance is C_{pd}=115 pF.

Timing specifications for the 74HC595 shift register include: (1) After ser-decode data transition, ser-decode clock must wait >40 ns, (2) Ser-decode data cannot change states after ser-decode clock until >3 ns, (3) Ser-decode latch must occur after last ser-decode clock pulse >50 ns, (4) The pulse width of Ser-decode clock and latch must be >50 ns, (5) The propagation delay after ser-decode clock and Q6 to Q7′ is ˜120 ns, (6) The propagation delay after ser-decode latch to Qₙ (shift-to-storage register) is ˜130 ns, (7) The maximum clock frequency (guaranteed) is 13 MHz, and (8) The rise/fall times of the input is 6 ns<tₜ<750 ns.

The 16 outputs of the 74HC154 are normally logic high, unless both enable lines (E0 and E1) are low. With that condition satisfied, the decoders 362 accept four active high binary address inputs and provide 16 mutually-exclusive low outputs—that is, the outputs “bubble” a logic low through following the 4-bit binary count given in TABLE 3.

TABLE 3

| An | Y0, Y1, Y2, . . .Y15 |
|---|---|
| 0000 | Yn = 0111111111111111 |
| 0001 | Yn = 1011111111111111 |
| 0010 | Yn = 1101111111111111 |
| 0011 | Yn = 1110111111111111 |
| .... | .... .... .... .... .... |
| 1111 | Yn = 1111111111111110 |

Timing specifications for the aforementioned 74HC154 4-to-16 decoder 362 (at 85° C.) is, (2) Transition time for An to Yn (address to output) is 55 ns (max), (3) Transition time for En to Yn (enable to output) is also 55 ns (max), (4) Propagation time for An to Yn is 110 ns (max), (5) and Propagation time for En to Yn is 110 ns (max)

Further the input capacitance for the address and enable pins is 3.5 pF each, and the quiescent current is 80 μA (640 μA for all 8 chips—total of P_{d}=3.3V·640 μA=2.11 mW. Additionally, power dissipation capacitance is C_{pd}=60 pF. Since only one HC154 decoder chip 362 is enabled and only two bits change states at any time, the power dissipation as derived from Equation (1) with C_{L}=3.0 pF at fᵢ=fₒ=812 kHz (i.e., 13 MHz/16) then P_{d}=1.38 mW. The total dynamic and static power dissipation is roughly P_{dtot}=3.5 mW.

The final tally for power dissipation at full capacity of the pulse sample board is <200 mW. At 3.3V the current draw is ˜37 mA.

Per chip, the quiescent supply current is 8 μA (typ.) giving a static power dissipation of Pₛ=26.4 μW at 3.3V. The input leakage current is 0.1 μA (typ). The input capacitance for the address and enable pins is 3.5 pF. The power dissipation capacitance is C_{pd}=60 pF.

### Start Up Pulse

With reference now to section D of FIG. 3, there is illustrated an initializer, designated by the numeral 370, where on power up, the decoders 360 are initialized to their proper states. As the 3.3V supply rises, this sends a logic high pulse that provisionally disables the decoders 360 in order to prevent more than one decoder, such as the aforementioned 74LV8154 decoder being on the data bus 340 at the same time—damage could occur with this condition. Afterwards, a high-to-low pulse 372 resets the serial registers 361A and 361B to zero.

### Regulator

With reference now to section E of FIG. 3, there is illustrated a regulator, designated by the numeral 380, which is optional. It should be understood that the on-board 3.3V voltage regulator 380 can be used to reduce IR drops and inductive kicks that can occur with fast rise/fall time pulses through supply traces and wires.

### Sallen and Key Active Lowpass Filter

With reference now to section F of FIG. 3, there is illustrated a filter, designated by the numeral 390, which is also optional in implementing the present invention. In order to provide a steady well-sourced V_{ref}, a<0.1 Hz optional, an on-board Sallen and Key filter 390 can be employed. Since negative references are needed, a negative supply voltage will be required, as is understood in the art.

### Power Dissipation Estimations

As is understood in the art, the power dissipation equation for logic devices is,

$${P}_{d} = {C}_{PD} \cdot {V}_{cc}^{2} \cdot {f}_{i} \cdot N + {V}_{cc} \cdot {I}_{cc} + {\sum }_{n = 1}^{N} {C}_{L} \cdot {V}_{cc}^{2} \cdot {f}_{o} \qquad ( 1 )$$

where fᵢ is the input frequency, N is the total number load switching outputs, and fₒ is the output frequency.

Using Equation (1) for the power dissipation of the top shift register 361A, there are 4 outputs (or loads of C_{L}=3.5 pF). The average bit transition is 1.875˜2 bits—so the average is 2 bits for 16 states. The top shift register 361A power dissipation is therefore, on the average P_{Dtop}=33 mW.

Using Equation (1) for the bottom shift register 361B, there are 8 outputs but since a “1” is bubbled through, only 2 bits a switch loads, again an average of 2 bits and P_{Dbottom}=33 mW. Therefore, the total dynamic and static power dissipation is roughly 66.5 mW.

The following equation places the static, switching, and load power dissipations into a single approximation:

$${P}_{d} = {V}_{p}^{2} \cdot [ {\sum }_{n = 1}^{Q} ( {C}_{PDn} \cdot {f}_{i n} \cdot {N}_{n} ) + {\sum }_{k = 1}^{U} ( {C}_{Lk} \cdot {f}_{ok} ) ] + {\sum }_{j = 1}^{M} ( {V}_{j} \cdot {I}_{j} ) \qquad ( 2 )$$

where Vₚ is the voltage pulse amplitude (assumed to be the same for all inputs), Q is the number of input gates, C_{PD} is the power dissipation capacitance, fi is the input frequency, N is the number of bits switching, U is the number of output bits, C_{Lk} are the various capacitive loads, fₒₖ are the various frequencies at the output, Vⱼ and Iⱼ are the different static voltages and currents, respectively and M is the number of static dc ports.

Applying Equation (2) to the supply, leakage, input capacitance and power dissipation capacitance found in the data for the aforementioned components, the following table estimates (with margin) the power consumption:

TABLE 4

| Device(s) | Power |
|---|---|
| 64 Comparators (MAX9144) | P_{comp} < 35 mW |
| 32 Dual-Binary IC chips (74LV8154) | P_{bin} < 45 mW |
| 8 4-to-16 decoders (74HC154) | P_{dec} < 0.25 mW |
| 2 Serial Shift Registers (74HC595) | P_{reg} < 0.70 mW |
| Total | Pₜₒₜ < 81 mW |

The total current used is ˜25 mA. If the optional on-board linear 3.3V regulator 380 is used, with a 5V feed, the extra power dissipation increases the total in Table 4 to ˜124 mW.

It should be understood that although preferred components have been discussed, alternative components that fall within the parameters of the invention, i.e. reducing the volume, weight and power consumption, are also contemplated.

It should be understood that the present invention offers a simple design that seamlessly captures 64 separate high-speed pluses of widths equal or greater than 4 nanoseconds and with less than 100 mW power consumption. As set forth hereinabove and understood in the art, the principles of the present invention are applicable to other detector configurations, and are not limited to the preferred 64 channel implementation described herein.

It should also be understood that, as shown in FIG. 3 and the textual description, the ultra-low power, presently-preferred 64-channel pulse data collection system (64-PDCS) design is preferably a 3.8 inch diameter electronic board with 64 inputs or channels that accept voltage pulses as high ˜2.9V and down to −300 mV with a +3.3V to ground voltage supply. The preferred invention accepts pulse rates up to 1 every microsecond that are counted within minimum frames or windows of 65.5 ms, leaving a rather negligible dead time of about 4 nanoseconds.

Preferably, five externally-controlled lines are needed to retrieve half-word count values for each channel that can be reconstructed by the command and data system. Also, an external reference voltage is preferable to set the threshold value to qualify a pulse. It should be understood that this reference voltage can be used to determine pulse height distribution, as well as various other discrimination functions. As is understood in the art, a negative supply voltage may be required if a filter is used for a negative reference voltage.

With reference now to FIG. 4 of the Drawings, there is illustrated therein a sounding rocket or other deployment device, generally designated by the reference numeral 400, that accommodates the data collection system and apparatus of the present invention. For example, in the payload of the sounding rocket 400, generally designated by the reference numeral 405, there is a satellite 410 for deployment that employs the present invention.

With further reference to FIG. 4, there is illustrated the satellite 410 deployed in space. A detector 415 detects the ions, positive or negative, or neutrals, such as ionospheric nitrogen and oxygen, and each hit is measured by a data collection unit, generally designated by the reference numeral 420, that implements the teachings of the present invention.

Also shown in FIG. 4 is a command unit 425, which includes memory therein for storing the data collected by the unit 420, and optionally relays that data via an antenna 430 to the ground or other satellites, as is understood in the art.

It should be understood that telemetry may be impractical due to the ionospheric interference, leaving the memory as the recordal mechanism for the data collection.

The present invention has a variety of applications in science measurements. For example, with a micro-channel plate and an array of well-placed anodes, a high-resolution (angular and energy) mass spectrometry can be realized to detect particles wind and temperature, such as the molecular species N₂ or the unstable species atomic oxygen (O) in ionosphere-thermosphere investigations.

Importantly, in conjunction with new NASA Goddard spectrometry technologies, the requirements of the aforementioned CubeSat program (NSF 8217), calling for small boards (<4×4 square inches) with very low power requirements, as composed to the CubeSat satellite electric bus having 4 watts.

It should be understood that other science applications of the present invention would be in the detection of the angular distributions of molecular compositions in low velocity plumes from comets, asteroids or other objects in the solar system, e.g., Apophis.

Another application would be as a multichannel-channel readout, such as the aforementioned 64-channel application described herein, for a linear array of SiC avalanche photodiodes (APDs) for single photon counting in ultraviolet (UV) applications for heliosphere sciences.

More generally, the system and apparatus of the present invention is used to detect and count 64 individual events, either as instrumentation as described or a part of an ASIC, as is understood.

While the foregoing written description of the invention enables one of ordinary skill to make and use what is considered presently to be the best mode thereof, it should be understood that various changes, substitutions and alterations can be made herein without departing from the spirit and scope of the invention as defined by the appended claims. Therefore, the invention is not to be limited by the above described embodiment, method, and examples, but by all embodiments and methods within the scope and spirit of the invention as claimed.

I claim:

1. A data collection apparatus comprising:
a multichannel data collector, said multichannel data collector receiving inputs from the environment and counting said inputs; and
a memory for storing the count of said inputs.

2. The data collection apparatus according to claim 1, further comprising:
a detector.

3. The data collection apparatus according to claim 2, wherein said detector is a micro-channel plate.

4. The data collection apparatus according to claim 1, wherein said multichannel data collector has a plurality of channels selected from the group consisting of: 16, 32, 64, 128, 256, 512 and 1,024 and combinations thereof.

5. The data collection apparatus according to claim 1, wherein said multichannel data collector has 64 channels

6. The data collection apparatus according to claim 1, wherein said multichannel data collector has a power requirement range of about 25 mW to about 500 mW.

7. The data collection apparatus according to claim 6, wherein said multichannel data collector has a power requirement range of about 50 mW to about 250 mW.

8. The data collection apparatus according to claim 1, wherein said multichannel data collector has a power requirement range of about 50 mW to about 100 mW.

9. The data collection apparatus according to claim 1, wherein said data collection apparatus is a mass spectrometer.

10. The data collection apparatus according to claim 1, wherein said inputs are from a source selected from the group consisting of: negative ions, positive ions, neutrals, molecular species, oxygen, nitrogen, photons and combinations thereof.

11. The data collection apparatus according to claim 1, wherein said data collection apparatus is implemented as an ASIC.

12. A data collection system comprising:
a detector, said detector receiving inputs from the environment;
a multichannel data collector, said multichannel data collector being connected to said detector, and counting said inputs; and
a memory for storing the count of said inputs.

13. The data collection system according to claim 12, wherein said detector is a micro-channel plate.

14. The data collection system according to claim 12, wherein said multichannel data collector has a plurality of channels selected from the group consisting of: 16, 32, 64, 128, 256, 512 and 1,024 and combinations thereof.

15. The data collection system according to claim 12, wherein said multichannel data collector has 64 channels

16. The data collection system according to claim 12, wherein said multichannel data collector has a power requirement range of about 25 mW to about 500 mW.

17. The data collection system according to claim 16, wherein said multichannel data collector has a power requirement range of about 50 mW to about 250 mW.

18. The data collection system according to claim 12, wherein said multichannel data collector has a power requirement range of about 50 mW to about 100 mW.

19. The data collection system according to claim 1, wherein said data collection system is a mass spectrometer.

20. The data collection system according to claim 12, wherein said inputs are from a source selected from the group consisting of: negative ions, positive ions, neutrals, molecular species, oxygen, nitrogen, photons and combinations thereof.

21. The data collection system according to claim 1, wherein said data collection system is implemented as an ASIC.
